(19) United States
(12) Patent Application Publication
(10) Pub. No.: US 2024/0317654 A1
(43) Pub. Date: Sep. 26, 2024

(54) INCORPORATION OF ALGINATE INTO FERTILIZER FOR QUALITY AND AGRONOMICAL BENEFITS

(71) Applicant: The Mosaic Company, Tampa, FL (US)

(72) Inventors: Jerri LIGHT, Regina (CA); Addison RICHARDS, Regina (CA); Murray SCHULTZ, Regina (CA)

(21) Appl. No.: 18/574,268

(22) PCT Filed: Jun. 23, 2022
(86) PCT No.: PCT/IB2022/000808

§ 371 Date: Dec. 26, 2023

Related U.S. Application Data
(60) Provisional application No. 63/214,244, filed on Jun. 23, 2021.

(51) Int. Cl. C05G 5/30; C05G 5/12

(52) U.S. Cl. CPC C05G 5/37; C05G 5/12

(57) ABSTRACT

A fertilizer product and method of making that includes a base fertilizer material such as a NPK based fertilizer that also includes an alginate. The alginate may be crosslinked with a cross-linking agent such as a divalent cation to produce a hydrogel. The alginate may be incorporated into the fertilizer product in the form of a protective layer, co-granulation, embedded component, or combinations thereof. The fertilizer product may also include a hydrophobic component such as an oil or wax that is emulsified with the alginate.

### RELATED APPLICATION

The present application claims the benefit of U.S. Provisional Application No. 63/214,244 filed Jun. 23, 2021, which is hereby incorporated herein in its entirety by reference.

### TECHNICAL FIELD

The present disclosure relates generally to fertilizer materials. More specifically, the invention relates to fertilizer materials that include alginates.

### BACKGROUND

Fertilizers provide critical macro- and micronutrients to soil and plants to promote soil health and plant growth. Plants access primary nutrients including nitrogen, phosphorus, and potassium from the soil, and hence they make up the major part of fertilizers used to supplement soils that are lacking in these nutrients. Traditionally, fertilizers are applied as small, dry granules or in a liquid form, which may be susceptible to runoff or degradation before the soil and plant can utilize the nutrients. Fertilizers may also be subject to harsh environmental conditions that inhibit proper absorption.

Alginates refer to naturally-occurring anionic polymers commonly found in brown algae and seaweed. Some typical sources of alginates from brown algae include Laminaria hyperborea, Laminaria digitata, Laminaria japonica, Ascophyllum nodosum, and Macrocystis pyrifer. Alginates can also be produced via bacterial biosynthesis from the bacteria Azotobacter and Pseudomonas. Alginates occur in the cell walls of seaweeds and may be present as mixed salts, primarily with sodium, calcium, magnesium, and potassium cations and some minor metal counter ions. The free acid form of alginate, alginic acid, and some alginates of certain divalent and polyvalent metal ions, are insoluble in water.

Alginates have been used in the pharmaceutical industry due to their biocompatibility and low toxicity. When divalent cations are added to alginates, the linear chains of alginate will cross-link together to form a network or hydrogels. Because of these features, alginates have been used in drug delivery systems to provide slow or delayed release of pharmaceutical compounds. Alginates also exhibit possess biodegradable and relatively nontoxic characteristics.

There remains a need of using the favorable properties of alignates in expanded markets, such as in fertilizers.

### SUMMARY OF THE DISCLOSURE

Embodiments of the invention are directed to a fertilizer granule product that includes an alginate, for example an alginate optionally complexed as a hydrogel, that can improve soil health, act as a carrier for other micronutrients, protect the base fertilizer material by providing hydrophobic properties, provide slow release properties to the fertilizer materials, and/or other benefits described below. In some examples the alginate may be incorporated as part of a protective layer substantially encapsulating the base fertilizer material. Additionally, or alternatively, the alginate may be co-granulated with a base fertilizer material to form fertilizer granules containing both particles of the base fertilizer material and the alginate, or may be blended into the base fertilizer material during granulation. In yet other embodiments, alginate capsules containing micronutrients dispersed in a carrier such as water with an alginate shell are co-granulated base material. The disclosure also describes methods of preparing the disclosed fertilizer granules.

In one embodiment, a fertilizer product can comprise a base fertilizer material, and a protective layer substantially encapsulating the base fertilizer material. The protective layer can include an alginate and optionally a hydrophobic material. A method of forming the encapsulated fertilizer product can comprise coating a granulated base fertilizer material with a powder comprising a cross-linking agent, and spaying the powder coated granulated base fertilizer material with a solution comprising an alginate and optionally a hydrophobic component to form a protective layer that substantially encapsulates the granulated base fertilizer material.

In another embodiment, a method of forming an encapsulated fertilizer product can comprise forming an emulsion comprising an aqueous solution and a hydrophobic component. The aqueous solution can include an alginate, and the hydrophobic component can include a cross-linking agent configured to crosslink with the alginate. The granulated base fertilizer material is then sprayed or coated with the emulsion to form a protective layer that substantially encapsulates the granulated base fertilizer material. The protective layer can then be dried.

In another embodiment, a fertilizer product can comprise a plurality of granules, each granule including a base fertilizer material, a hydrogel comprising an alginate cross-linked with a cross-linking agent, and optionally a hydrophobic material. In embodiments, the hydrogel is embedded within the base fertilizer material, such as by co-granulating or compacting the base fertilizer material and the hydrogel together. A method of forming a fertilizer product can comprise mixing a base fertilizer material with a cross-linking agent to form a fertilizer mixture, and spraying the fertilizer mixture with a solution comprising an alginate and optional hydrophobic component during granulation of the fertilizer mixture to form a granulated fertilizer product.

In some embodiments, the cross-linking agent is added a ratio of up to 5:1 by weight relative to the alginate. In some embodiments, the cross-linking agent is a divalent cation. The divalent cation can comprise calcium chloride, calcium carbonate, calcium sulfate, magnesium chloride, or combinations thereof. In embodiments, the fertilizer product comprises an emulsion containing the alginate and the hydrophobic component. In embodiments, the alginate and the cross-linking agent form a hydrogel.

In embodiments, the base fertilizer material can comprise a nitrogen-based fertilizer, a potassium-based fertilizer, a phosphate-based fertilizer, or combinations thereof. In embodiments, the hydrophobic component is a wax or an oil. In embodiments, the hydrophobic component is present at an amount of about 1 weight percent (wt. %) to about 90 wt. % relative to the alginate.

The above summary of the invention is not intended to describe each illustrated embodiment or every implementation of the present invention. The detailed description that follows more particularly exemplifies these embodiments.

### BRIEF DESCRIPTION OF THE DRAWINGS

FIG. 1 is a schematic cross-sectional image of a fertilizer product that includes a base fertilizer material substantially encapsulated with a protective layer including an alginate.

FIG. 2 is a schematic cross-sectional image of a fertilizer product that includes a blended mixture of a base fertilizer material and an alginate material.

FIG. 3 is a schematic cross-sectional image of a fertilizer product that includes a base fertilizer material and an alginate material co-granulated together.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Embodiments of the invention are directed to utilizing alginates with fertilizers to provide beneficial effects to soil health and crop plants. Using alginates in fertilizers can provide biological benefits to soil and crop plant health. For example, seaweeds have been found to provide positive impacts on seed germination and establishment, as well as crop performance and yield of growth, in addition to providing resistance to biotic and abiotic stress. Seaweed products also may exhibit growth-stimulating and biostimulant activities and provide macro- and microelement nutrients, amino acids, vitamins, cytokinins, auxins, and abscisic acid-like growth substances that may affect cellular metabolism in treated plants, leafing to enhance growth, and yield. Seaweed may also affect the physical, chemical, and biological properties of the soil by improving moisture-holding capacity and promoting the growth of beneficial soil microbes. Brown seaweeds are rich in polyuronides such as alginates and fucoidans. The gelling and chelating abilities of these polysaccharides coupled with their hydrophilic properties make these compounds important in food processing and in the agricultural and pharmaceutical industries. Seaweed extracts are bioactive at low concentrations (diluted as 1:1000 or more).

One study showed that alginate oligosaccharides, produced by enzymatic degradation of alginic acid mainly extracted from brown algae, significantly stimulated hyphal growth and elongation of arbuscular mycorrhizal (AM) fungi and triggered their infectivity on trifoliate orange seedlings. Extracts of various marine brown algae (Laminaria japonica) could be used as an AM fungus growth promoter. From the same study, Indigenous AM fungi demonstrated a 27% improvement in root colonization, while spore number was increased about 21% over the controls when liquid fertilizer containing tangle (L. japonica) extracts was applied via a sprinkler system in a citrus orchard. Researchers also reported that organic fractions (25% MeOH eluates) of red and green algae considerably improved in vitro hyphal growth of AM fungi. Their results showed that application of the 25% MeOH eluates of red and green algal extracts to roots of papaya (Carica papaya Linn.) and passion fruit (Passiflora edulis Sims.) improved mycorrhizal development more than the control treatment. Results implied that both red and green algae have AM stimulatory compounds which play a part in mycorrhizal development in higher plants.

Because of their unique physical properties, certain kinds of alginates may be selectively used in a variety of formulations in fertilizers to provide specific benefits. For example, alginates may be used to slow or delay the release of nutrients in a fertilizer, impart positive effects on soil health, provide biostimulant affects to the soil, microbes, or crop plants, or to improve the quality of the fertilizer granules. Alginates are biodegradable and relatively non-toxic, making them an attractive option for use in fertilizer. Further, when combined with metallic ions in the soil, salts of alginic acid can absorb and retain moisture by swelling, improving the crumb texture of soil and soil aeration. This may improve capillary activity of soil pores to stimulate growth of a plant's root system and boost soil microbial activity.

Alginates can be used to produce a hydrogel by various cross-linking methods including using divalent cations such as Ca2+, Mg2+ etc. The hydrogel incorporation of the alginate and metallic ions in the soil can form high-molecular-weight complexes that absorb moisture, swell, retain soil moisture, and improve crumb structure. This results in better soil aeration and capillary activity of soil pores which in turn stimulate the growth of the plant root system as well as boost soil microbial activity.

The physical properties of an alginate hydrogel may depend on the source of the alginate, the cross-linking methods and molecules, and the other components incorporated into the gel. For example, alginates include repeating block structure of (1,4)-linked β-D-mannuronate (M) and α-L-guluronate (G) along the polymer backbone. Typically, alginates will contain combinations of blocks of consecutive G residues (GGGGGG), consecutive M residues (MMMMM), and alternating residues (GMGMGM). The G and M content of an alginate and the length of the blocks is dependent on where the alginate is sourced. Without being bound by scientific theory, it is believed that the G residues participate are the predominate participant in the cross-linking reactions that produce the hydrogel. Thus, the ratio of G to M residues, the sequence, length of G blocks, and molecular weight of an alginate can affect the physical properties of the gel formed by an alginate. The mechanical properties of alginate gels typically are enhanced by increasing the length of G-block and molecular weight. Different alginate sources provide polymers with a range of chemical structures (e.g., bacterial alginate produced from Azotobacter has a high concentration of G-blocks producing hydrogels having a relatively high stiffness compared to alginates with a higher M-block content).

In some embodiments, the resultant alginate hydrogels may be used to carry and deliver various molecules to the soil ranging in size from micronutrient and small chemical drugs to macromolecular proteins. The carried materials can be released from alginate hydrogels in a controlled manner, depending on the cross-linker types and cross-linking methods. The physical properties of the hydrogel (e.g., swellability, cross-linking capabilities) control the stability of the gels and the rate of molecule release (e.g., such as a micronutrient) from the hydrogel into the surrounding soil. Thus, alginate hydrogels may provide a slow or delayed release delivery mechanism of micronutrients that would otherwise leach in acidic environments (for example, boron). The disclosed alginate materials may also sustainable positive soil health impacts to customer crops, over and above standalone fertilizer products and provide a biostimulant effect in a wide range of soils and crops due to the positive interactions on both soil microbes and crop plants.

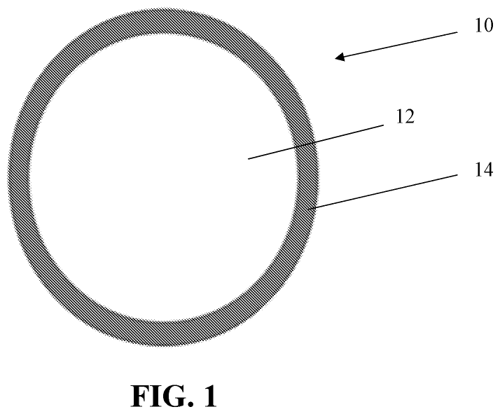

Referring now to FIG. 1, a schematic cross-sectional image of a fertilizer product 10 is depicted according to an embodiment that includes a base fertilizer material 12 substantially encapsulated (e.g., fully encapsulated or nearly encapsulated) with a protective layer 14 that includes an alginate. As described further below, the protective layer 14 can include the alginate material on its own or as a hydrogel. Additionally, in some embodiments, the protective layer may also include a hydrophobic material such as a wax or oil.

Base fertilizer material 12 can be any suitable material. In some embodiments, base fertilizer granule 12 can comprise any of a variety of suitable NPK fertilizers, including, for example, a nitrogen-based fertilizer (e.g., urea), a potassium-based fertilizer (e.g. potash or muriate of potash (MOP)), or a phosphate-based fertilizer (e.g. MAP, DAP, and/or TSP), or combinations thereof. Base fertilizer material 12 can also optionally contain or be co-granulated with one or more sources of micronutrients and/or secondary nutrients including, but not limited to, micronutrients including boron (B), zinc (Zn), manganese (Mn), molybdenum (Mo), nickel (Ni), copper (Cu), iron (Fe), and/or chlorine (CI), and/or secondary nutrients including an a source of sulfur (S) in its elemental form, sulfur in its oxidized sulfate form (SO₄), magnesium (Mg), and/or calcium (Ca), or any of a variety of combinations thereof at various concentrations.

Protective layer 14 substantially encapsulates base fertilizer material 12 and one or more alginate materials. To produce protective layer 14, the alginate polymer may be applied and crosslinked over base fertilizer material 12 to establish a hydrogel that substantially encapsulates the base granule.

The crosslinking process may be produced in a variety of ways including via ionic or co-valent cross-linking. In ionic cross-linking, the hydrogel may be prepared from an aqueous alginate solution that is combined with ionic cross-linking agents, such as divalent cations (i.e., Ca2+ or Mg2+). The divalent cations are believed to bind solely to G-blocks of the alginate chains, as the structure of the guluronate blocks allows a high degree of coordination of the divalent ions. The G-blocks of one polymer then form junctions with the G-blocks of adjacent polymer chains, qresulting in a gel structure. Calcium chloride (CaCl₂)), calcium sulfate (CaSO₄) and calcium carbonate (CaCO₃) are example calcium sources that may be used to develop the ionic cross-linking with the alginate.

One challenge with creating the ionic cross-linking with the alginate material is the rate at which cross-linking and gelation occurs. CaCl₂) typically leads to rapid and poorly controlled gelation due to its high solubility in aqueous solutions. In some examples, the gelation may be slowed and controlled using a buffer containing phosphate (e.g., sodium hexametaphosphate), as phosphate groups in the buffer compete with carboxylate groups of alginates in the reaction with calcium ions thereby slowing gelation. If the crosslinking and gelation occurs too rapidly, the gelation may occur prior to application of the material to base fertilizer material 12. Thus, it may be beneficial to slow the rate of gelation or have the gelation occur after application to ensure sufficient encapsulation of base fertilizer material 12.

CaSO₄ and CaCO₃, due to their lower solubilities, may also slow the gelation rate and widen the working time for alginate hydrogels. For example, an alginate solution can be mixed with CaCO₃, which is not soluble in water at neutral pH. Glucono-δ-lactone may then be added to the alginate/CaCO₃ mixture in order to dissociate Ca2+ from the CaCO₃ by lowering the pH. The released Ca2+ subsequently initiates the gelation of the alginate solution in a more gradual manner. Thus, the solution may be pre-mixed and sprayed onto base fertilizer material 12 where subsequent gelation then occurs to provide protective layer 14.

The gelation rate contributes to controlling gel uniformity and strength when using divalent cations, and slower gelation rates may produce more uniform structures and thereby improve mechanical integrity or protective layer 14. The gelation temperature may also influence gelation rate, and the resultant mechanical properties of the hydrogel protective layer 14. At lower application temperatures, the reactivity of ionic cross-linkers (e.g. Ca2+ or Mg2+) is reduced, and cross-linking rate and thereby gelation rate becomes slower. The resulting cross-linked network structure may also have greater order, leading to enhanced mechanical properties of resultant protective layer 14. As mentioned previously, the mechanical properties of ionically cross-linked alginate hydrogels can vary depending on the chemical structure of alginate. Thus, controlling the rate of gelation combined with the chemical structure of the selected alginate can be selected to provide desired physical properties in the final product.

Ionically cross-linked alginate hydrogels may exhibit reduced limited long-term stability in physiological conditions because these hydrogels can be dissolved due to release of divalent ions into the surrounding media due to exchange reactions with monovalent cations. These features may be beneficial or negative, depending on the situation (e.g., whether short term or long-term release of materials contained in the hydrogel or base fertilizer material 12 is desired).

In examples where it is preferred to have greater long-term stability of the hydrogel, it may be preferable to provide a covalently cross-linked alginate hydrogel. Covalent cross-linking has investigated to improve the physical properties of hydrogels for many applications. The stress applied to an ionically cross-linked alginate hydrogel relaxes as the cross-links dissociate and reform elsewhere, and water is lost from the gel, leading to plastic deformation. While water migration also occurs in covalently cross-linked gels leading to stress relaxation, the inability to dissociate and reform bonds allows the gel to maintain elastic deformation characteristics. However, increased scrutiny of the cross-linking agent should be followed to ensure the resultant hydrogel remains non-toxics and meets environmental standards.

Covalent cross-linking of alginate may be performed with suitable cross-linkers such as poly(ethylene glycol)-diamines of various molecular weights. Studies have shown that while the elastic modulus initially increased gradually with an increase in the cross-linking density or weight fraction of poly(ethylene glycol) (PEG) in the hydrogel, it subsequently decreased when the molecular weight between cross-links became less than the molecular weight of the softer PEG. It was subsequently demonstrated that the mechanical properties and swelling of alginate hydrogels can be tightly regulated by using different kinds of cross-linking molecules, and by controlling the cross-linking densities. The chemistry of the cross-linking molecules may also influence the hydrogel swelling. The introduction of hydrophilic cross-linking molecules as a second macromolecule (e.g., PEG) can compensate for the loss of hydrophilic character of the hydrogel resulting from the cross-linking reaction.

In one embodiment, protective layer 14 may include a hydrogel comprising an alginate in combination with or without a hydrophobic material. For example, in absence of the hydrophobic material, base fertilizer material 12 may be granulated and mixed with a dry powder cross-linking agent. The two components may be mixed together (e.g., tumbled) to provide a powder coating of the cross-linking agent on the outside of the granulated base fertilizer 12. Next, the powder coated base fertilizer materials may be spray coated with an aqueous solution that includes the alginate (e.g., about 1-10% by weight alginate solution). Upon contact with the powdered cross-linking agent, the alginate will cross link producing the hydrogel protective layer 14. The cross-linking agent and alginate may be added at any suitable ratio such as up to a ratio of 5:1 of the crosslinking agent to alginate by weight. In some such examples, the protective layer may predominately be made of the hydrogel alginate (e.g., is composed of more than 50 weight percent (wt. %)).

To ensure proper moisture control within final fertilizer product 10, the hydrogel coating may be heated to dehydrate protective layer 14 to remove moisture and to provide a solid coating during storage and transportation. In some examples, the coated product may be heated/dehydrated to a final moisture content of less than 5% by weight, and more specifically, less than 3% by weight.

In other examples, a hydrophobic component may be included in the protective layer 14 to help solidify the outer layer, control moisture content, modify release profile of the material, or the like. In such examples, the aqueous solution described above may be blended with about 1 wt. % to about 90 wt. % oil or wax to form an emulsion. The emulsion would then be applied at high temperature to powder coated base fertilizer 12 where the alginate and crosslinking agent will at least partially react to form the disclose alginate hydrogel. The application temperature should remain high enough to ensure any oil or wax components remained in a sprayable, molten form (e.g., greater than 55 degrees C.). Once sufficiently covered, the product may be cooled to room temperature to allow protective layer 14 to solidify, thereby encapsulating base fertilizer material 12. Optionally, resultant fertilizer product 10 may be dehydrated further to a desired final moisture content.

In another embodiment that includes the hydrophobic material, the crosslinking agent and the alginate may be combined in separate phases and spray applied to base fertilizer material as an emulsion. For example, using the ratios described above, the alginate may be dissolved in an aqueous solution while the crosslinking agent (divalent cations such as CaCl₂), MgCl₂, or the like) is dissolved or suspended into a heated wax or oil (e.g., heated sufficiently enough to produce a liquid). The aqueous alginate solution and oil or wax hydrophobic solution containing the crosslinking agent would then be emulsified together and spray applied to the base fertilizer granules. The migration of the alginate and cross-linking agent would allow the materials to react and produce the described hydrogel. Once coated, the granules would be allowed to cool to solidify protective coating 14. Further dehydration may be performed as desired.

In some embodiments, protective coating 14 may also include one or more beneficial additives such as micronutrients that are released from the hydrogel into the soil over time. These additives may be combined in the aqueous or hydrophobic phases described above. Additionally, or alternatively, the additives may be included with base fertilizer material 12. Such additive may include, but are not limited to, micronutrients and/or secondary nutrients, such as micronutrients including boron (B), zinc (Zn), manganese (Mn), molybdenum (Mo), nickel (Ni), copper (Cu), iron (Fe), and/or chlorine (Cl), and/or secondary nutrients including an additional source of sulfur (S) in its elemental form, sulfur in its oxidized sulfate form (SO₄), magnesium (Mg), and/or calcium (Ca), or any of a variety of combinations thereof at various concentrations.

The disclosed alginate materials and protective coating 14 may also offer improvements in product quality or handling experience. Fertilizer products are notoriously dusty and sensitive to degradation, especially if exposed to high temperatures and high humidity. The disclosed protective layer 14 incorporating the alginate material could offer a positive improvement in these quality metrics and therefore improve customer experience and perhaps also allow expansion into market places where select fertilizer product could not otherwise withstand environmental conditions.

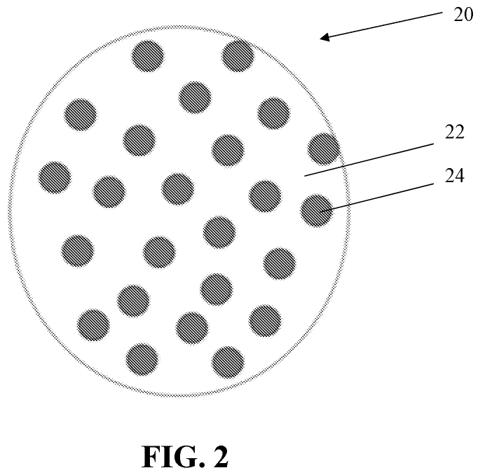

FIG. 2 is a schematic cross-sectional image of a fertilizer product 20 that includes a blended mixture of a base fertilizer material 22 and an alginate material 24. The two components may be combined and compacted together in any suitable matter. In some embodiments, the cross-linking agent may be initially mixed with base fertilizer material (e.g., at up to about a 5:1 ratio relative to the alginate). If feed does not have sufficient cross-linking cations, a selection of divalent cations (including Ca, Mg, etc.) could be blended in with the feed in a concentration that produces up to 5:1 ratio with the alginate solution concentration.

The fertilizer material containing the cross-linking agent then may be blended with an aqueous material containing the dissolved alginate (e.g., solution containing 1-10% alginate). Once combined and blended, the crosslinking agent and alginate will react to form the disclosed hydrogel alginate material 24 embedded within base fertilizer material 22. Such examples may also include the disclosed hydrophobic materials in the blend if desired. After mixing, the resultant fertilizer product 20 may be sent through conventional processing techniques to granulate the product into a plurality of granules. Fertilizer product 20 may them be sprayed with a conventional dust control agent (DCA) as traditionally applied to some fertilizer products, or alternatively coated with the encapsulation protective layer 14 described herein.

In another example, base fertilizer material 22 and alginate material 34 in a dry form can be combined together prior to fertilizer compaction. The dry alginate material may be included at an amount of about 1 wt. % to about 10 wt. % of the base fertilizer 22. The material may be compacted together using conventional techniques. Fertilizer product 20 may them be sprayed with typical DCA, and/or alternatively coated with the encapsulation protective layer 14 described herein.

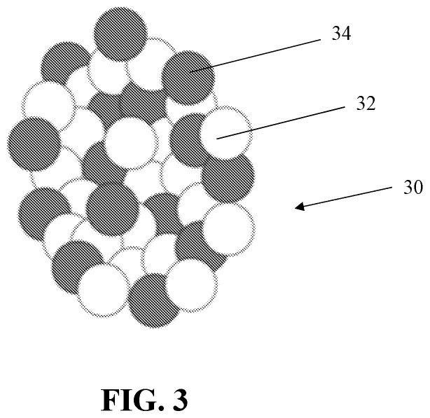

FIG. 3 is a schematic cross-sectional image of a fertilizer product 30 that includes a base fertilizer material 32 and an alginate material 34 co-granulated together. For example, a dry alginate material previously granulated may be added to the fertilizer compaction feed of a base fertilizer material at an amount of about 1 wt. % to about 10 wt. % of base fertilizer material 32. The granulation may be performed using traditional techniques to produce a particle fertilizer product 30. Fertilizer product 30 may them be sprayed with typical DCA, and/or alternatively coated with the encapsulation protective layer 14 described herein.

In another embodiment, the alginate material and base fertilizer materials may be mixed together to form a fertilizer product. The alginate material may be in the form of hydrogel spheres or capsules containing micronutrient, secondary nutrient, and/or primary nutrient materials dispersed or dissolved within a carrier such as water. For example, alginate may be dissolved (e.g., between 1-10 wt. %) in a water-based carrier. Similarly, powdered micronutrient material containing divalent cations (e.g., sources of Ca²⁺, Zn²⁺, Mg²⁺, etc.) may be dissolved (e.g., between 1-10 wt. %) in a compatible water-based carrier. The aqueous solution containing the alginate may then be added in a drop-wise fashion to the solution containing the divalent cations to form the hydrogel. The dropwise addition produces a plurality of microspheres of hydrogel material containing the alginate and encapsulated micronutrient material. The hydrogel spheres may be removed from the solution and mixed with a base fertilizer material.

In some embodiments, the alginate material may be extruded with the base fertilizer material to produce granules (e.g., pellets) of fertilizer material. For example, alginate may be dissolved (between 1-10 wt. %) in a water-based carrier. A cross-linking agent such as a divalent cation may be dissolved or suspended into a heated wax or oil (e.g., heated sufficiently enough to melt the wax/oil component i.e. >55 degrees Celsius) at a relative concentration that would result in up to about a 5:1 ratio with the alginate. The aqueous solution containing the alginate may then be emulsified into one or all of cross-linker/emulsifier/wax combinations. The molten emulsion could then be mixed and extruded with the base fertilizer material to form a mixed fertilizer product. The mixture can be extruded through a die cast to a specific size and shape. Partial cooling during and after the extrusion process would allow the molten granules to harden and set, producing the fertilizer granules.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A fertilizer product comprising:
a base fertilizer material; and
a protective layer substantially encapsulating the base fertilizer material, the protective layer comprising an alginate and optionally a hydrophobic material.

2. A method of forming an encapsulated fertilizer product comprising:
coating a granulated base fertilizer material with a powder comprising a cross-linking agent; and
spaying the powder coated granulated base fertilizer material with a solution comprising an alginate and optionally a hydrophobic component to form a protective layer that substantially encapsulates the granulated base fertilizer material.

3. A method of forming an encapsulated fertilizer product comprising:
forming an emulsion comprising an aqueous solution and a hydrophobic component, wherein the aqueous solution comprises an alginate, and wherein the hydrophobic component comprises a cross-linking agent configured to crosslink with the alginate;
spaying a granulated base fertilizer material with the emulsion to form a protective layer that substantially encapsulates the granulated base fertilizer material.

4. The method of claim 2, further comprising drying the protective layer.

5. The fertilizer product of claim 1, wherein the protective layer is formed by cross-linking the alginate with a cross-linking agent.

6. A fertilizer product comprising a plurality of granules:
a base fertilizer material;
a hydrogel comprising an alginate cross-linked with a cross-linking agent; and
optionally a hydrophobic material.

7. The fertilizer product of claim 6, wherein each granule of the plurality of granules comprises: the base fertilizer material and the hydrogel embedded within the base fertilizer material.

8. The fertilizer product of claim 6, wherein each granule of the plurality of granules comprises: the base fertilizer material and the hydrogel co-granulated together.

9. The fertilizer product of claim 6, wherein each granule of the plurality of granules comprises: a plurality of microspheres comprising the hydrogel.

10. The fertilizer product of claim 6, wherein the base fertilizer material and the hydrogel are mixed and extruded together to form the fertilizer product.

11. A method of forming a fertilizer product comprising:
mixing a base fertilizer material with a cross-linking agent to form a fertilizer mixture; and
spraying the fertilizer mixture with a solution comprising an alginate and optional hydrophobic component during granulation of the fertilizer mixture to form a granulated fertilizer product.

12. The method of claim 11, wherein the cross-linking agent is added a ratio of up to 5:1 by weight relative to the alginate.

13. The method of claim 11, wherein the cross-linking agent is a divalent cation.

14. The method of claim 13, wherein the divalent cation is calcium chloride, calcium carbonate, calcium sulfate, magnesium chloride, or combinations thereof.

15. The method of claim 11, wherein the fertilizer product comprises an emulsion containing the alginate and the hydrophobic component.

16. The method of claim 11, wherein the alginate and the cross-linking agent form a hydrogel.

17. The method of claim 11, wherein the base fertilizer material comprises a nitrogen-based fertilizer, a potassium-based fertilizer, a phosphate-based fertilizer, or combinations thereof.

18. The method of claim 11, wherein the hydrophobic component is a wax or an oil.

19. The method of claim 11, wherein the hydrophobic component is present at an amount of about 1 weight percent (wt. %) to about 90 wt. % relative to the alginate.
